(19) United States
(12) Patent Application Publication
(10) Pub. No.: US 2023/0300227 A1
(43) Pub. Date: Sep. 21, 2023

(54) APPARATUS FOR FACILITATING NULLIFYING ENVIRONMENTAL SOUNDS FOR A DEVICE

(71) Applicant: Ian Alexander Brown, Jurupa Valley, CA (US)

(72) Inventor: Ian Alexander Brown, Jurupa Valley, CA (US)

(21) Appl. No.: 18/122,099

(22) Filed: Mar. 15, 2023

Related U.S. Application Data
(60) Provisional application No. 63/320,663, filed on Mar. 16, 2022.

(51) Int. Cl. H04M 1/02; A45C 11/00

(52) U.S. Cl. CPC H04M 1/0202; A45C 11/00; A45C 2011/002

(57) ABSTRACT

An apparatus for facilitating nullifying environmental sounds for a device. The apparatus may include a cover configured to be attached to an outer surface of the device. Further, the cover may include a holder attached to the cover in a location of the cover. Further, the holder defines a interior space. Further, the apparatus may include a filtering component configured to be disposed in the interior space. Further, the filtering component covers an opening disposed in the outer surface of the device based on the attaching of the cover to the outer surface of the device. Further, the opening leads to a cavity in the device for a sound capturing device comprised within the device. Further, the filtering component may be comprised of a material. Further, the filtering component may be configured for suppressing a capturing of an environmental sound by the sound capturing device based on the material.

### CROSS-REFERENCE TO RELATED APPLICATION

This application claims the benefit of U.S. Provisional Patent Application No. 63/320,663, titled “AN APPARATUS FOR FACILITATING NULLIFYING WIND SOUND FOR A DEVICE”, filed on 16 Mar. 2022, which is incorporated by reference herein in its entirety.

### FIELD OF THE INVENTION

Generally, the present disclosure relates to the field of purses, wallets, and protective covers. More specifically, the present disclosure relates to an apparatus for facilitating nullifying environmental sounds for a device.

### BACKGROUND OF THE INVENTION

The field of purses, wallets, and protective covers is technologically important to several industries, business organizations, and/or individuals. In particular, the use of purses, wallets, and protective covers is prevalent for apparatus for facilitating nullifying environmental sounds for a device.

When trying to record a video or having a conversation over the phone on a slightly windy day, the microphone for the cell phone may pick up annoying wind noises and sounds making it hard for the audio to be heard clearly. Further, cleaning out the microphone holes can lead to other mechanical problems if done improperly. Existing techniques for facilitating nullifying wind sound for a device are deficient with regard to several aspects. For instance, current protective phone cases for mobiles comprise a mesh screen over a microphone portion of the protective phone case. The mesh screen doesn't provide enough protection for the microphone. Furthermore, current technologies do not include a material in the protective phone cases for solving the wind issue from the audio. Furthermore, current technologies provide poor audio quality while recording video or during a phone conversation.

Therefore, there is a need for an improved apparatus for facilitating nullifying environmental sounds for a device that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for facilitating nullifying environmental sounds for a device, in accordance with some embodiments. Accordingly, the apparatus may include a cover configured to be attached to an outer surface of the device. Further, the cover may include at least one holder attached to the cover in at least one location of the cover. Further, the at least one holder defines at least one interior space. Further, the apparatus may include at least one filtering component configured to be disposed in the at least one interior space. Further, the at least one filtering component covers at least one opening disposed in the outer surface of the device based on the attaching of the cover to the outer surface of the device. Further, the at least one opening leads to at least one cavity in the device for at least one sound capturing device comprised within the device. Further, the at least one filtering component may be comprised of at least one material. Further, the at least one filtering component may be configured for suppressing a capturing of at least one environmental sound by the at least one sound capturing device based on the at least one material.

Further disclosed herein is an apparatus for facilitating nullifying environmental sounds for a device, in accordance with some embodiments. Accordingly, the apparatus may include a cover configured to be attached to an outer surface of the device. Further, the cover may include at least one holder attached to the cover in at least one location of the cover. Further, the at least one holder defines at least one interior space. Further, the apparatus may include at least one filtering component configured to be disposed in the at least one interior space. Further, the at least one filtering component covers at least one opening disposed in the outer surface of the device based on the attaching of the cover to the outer surface of the device. Further, the at least one opening leads to at least one cavity in the device for at least one sound capturing device comprised within the device. Further, the at least one filtering component may be comprised of at least one material. Further, the at least one filtering component may be configured for suppressing a capturing of at least one environmental sound by the at least one sound capturing device based on the at least one material. Further, the at least one material may include at least one interchangeable media layer.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an exploded front perspective view of an apparatus 100 for facilitating nullifying environmental sounds for a device (such as a device 402), in accordance with some embodiments.

FIG. 2 is a front right side perspective view of the apparatus 100, in accordance with some embodiments.

FIG. 3 is a side perspective view of the apparatus 100, in accordance with some embodiments.

FIG. 4 is a front left side perspective view of the apparatus 100 with the device 402, in accordance with some embodiments.

FIG. 5 is a rear view of the apparatus 100, in accordance with some embodiments.

FIG. 6 is a front perspective view of the apparatus 100 with the device 402, in accordance with some embodiments.

FIG. 7 is a front left side perspective view of the apparatus 100 with the device 402, in accordance with some embodiments.

FIG. 8 is a front view of an apparatus 800 for facilitating nullifying environmental sounds for a device, in accordance with some embodiments.

FIG. 9 is a top view of the apparatus 800, in accordance with some embodiments.

FIG. 10 is an enlarged partial rear view of the apparatus 800, in accordance with some embodiments.

FIG. 11 is an enlarged partial rear view of the apparatus 800, in accordance with some embodiments.

FIG. 12 is a bottom view of the apparatus 800, in accordance with some embodiments.

FIG. 13 is an enlarged partial bottom view of the apparatus 800, in accordance with some embodiments.

FIG. 14 is a front view of an apparatus 1400 for facilitating nullifying environmental sounds for a phone 1402 with the phone 1402, in accordance with some embodiments.

FIG. 15 is a front view of an apparatus 1500 for facilitating nullifying environmental sounds for a smartwatch 1502 with the smartwatch 1502, in accordance with some embodiments.

FIG. 16 is an exploded front perspective view of an apparatus 1600 for facilitating nullifying environmental sounds for a device, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of apparatus for facilitating nullifying environmental sounds for a device, embodiments of the present disclosure are not limited to use only in this context.

Overview:

The present disclosure describes an apparatus for facilitating nullifying environmental sounds for a device. The disclosed apparatus includes an environmental microphone cover for a phone and smart watches (body cameras, go pros). Further, the apparatus may be used in the form of a phone case and a case for the watch to cover any or all of the microphone and speaker portion and locations with at least one layer or layer of woven fabric (high density or low density). Further, the apparatus may be used by simply attaching the case to a phone or smartwatch like any standard case. Further, the apparatus may be designed to provide professional studio-quality audio recordings without the large and expensive equipment. The apparatus may eliminate any need for editing to enhance audio quality. The fabric for reducing and filtering wind noise may also block dirt, dust, and debris from entering the microphone/speakers preventing damage and buildup within.

Further, the disclosed apparatus may include an environmental microphone cover (or a wind/gust nullifier) for cell phones and smartwatches. When trying to record a video on a slightly windy day, the microphone for the cell phone may pick up annoying wind noises and sounds making it hard for the audio to be heard clearly.

The apparatus incorporates techniques used in the music/voice industry during recording in a studio. A pop shield/screen is used in the music/voice industry in order to filter out undesirable sounds of wind gusts created by naturally talking or breathing. The wind from breath gets broken up by the filter which clarifies and enhances the quality of words while being recorded. This is the technique that I will apply to some or all microphone locations in order to provide the best quality sound possible within one item (phone/watch case). Further, by encasing a filter within the case for any given device (smartphone, watch, body cam, go pros) that goes around the outer circumference of the device, a better quality sound may be provided. The filter may be housed in a separate chamber. The filter may be freestanding or attached by a number of methods within the housing. The filter may be made to be perforated for sound altering set consisting of sound amplification, sound blocking, sound filtering, sound reducing, and sound collecting. Further, the apparatus may be used with other smart devices such as body cams and go pros to reduce wind and ambient noise.

Further, the environmental microphone cover may include a layered fabric such as a pop screen or any woven fabric placed over the microphone area of the phone or smartwatch. The layered fabric may be layered inside of a housing which can be attached to the phone either in the form of a phone case or as a separate attachment to the phone case itself. Further, the layered fabric breaks up the air before it hits the microphone to enhance the clarity of words heard by the microphone which would make the sound clear. Further, in some embodiments, it may be possible to attach the layered fabric to the interior of the cell phone or smartwatch. Further, the layered fabric may be placed on either the inside of the device or inside the body or an attachment to cover the surface of the microphone.

Further, the layered fabric may include layers of protection that break up harmful wind for a more pleasing sound. Further, the disclosed apparatus may significantly reduce wind noise.

Further, the environmental microphone cover (or removable microphone cover) may be built into the phone case. Further, the microphone cover may be used for the smartphone. Further, the layered fabric may include layers of interchangeable media and spacer. Further, the layer of media may be disposed inside an interior of a phone or smartwatch where the microphone is located.

The environmental microphone cover may be applied to other smart devices such as body cams and go pros because they combine audio with visuals in the same unit. This will also help reduce wind and ambient noise. Further, the disclosed apparatus may be used in the form of a phone case and a case for the watch to cover any or all of the microphone and speaker portion and locations with at least one layer or layer of woven fabric (high density or low density). Further, the environmental microphone cover may be used by simply attaching the case to a phone or smartwatch like any standard case.

Further, the disclosed apparatus may provide professional studio-quality audio recordings without the large and expensive equipment. Further, the disclosed apparatus cuts down or eliminates any need for editing. The fabric may reduce and filter wind noise that may also block dirt, dust, and debris from entering the microphone/speakers preventing damage and build-up within. This may reduce or eliminate the hassle of having to clean out the microphone holes which can lead to other mechanical problems if done improperly. It is important to note that the sound quality is affected heavily by the microphone that is closest to the camera on a phone such as an iPhone. It is important to cover that particular area with an attachment stemming from the phone case and yet still part of the phone case.

Further, the disclosed apparatus may incorporate techniques used in the music/voice industry while they are in a studio recording. The pop shield/screen may filter out undesirable sounds of wind gusts created by naturally talking or breathing. The wind from your breath gets broken up by a filter (such as the pop shield/screen) which clarifies and enhances the quality of your words while being recorded. This is the technique that may be applied to some or all microphone locations in order to provide the best quality sound possible within one item (phone/watch case). This may be achieved by encasing the filter within the case for any given device (smartphone, watch, body cam, go pros) that goes around the outer circumference. The filter itself may be housed in a separate chamber that can contain the filter. The chamber (or enclosure) may be left open or closed on the interior. The filter can be freestanding or attached by a number of methods within the housing. The benefits of the disclosed apparatus may not only be heard while recording but when having a standard conversation with others.

Further, the apparatus may include a device case configured for snugly fitting the device using a mechanism. Further, the device may include a smartphone, a tablet, a mobile, a smartwatch, a body cam, and go pros. Further, the mechanism may be configured for securing the device to the apparatus. Further, the apparatus may include a filtering component for covering at least one of at least one microphone and at least one speaker comprised in the device. Further, the filtering component may be housed in a chamber. Further, the chamber may include a receptacle configured for storing the filtering component. Further, the filtering component may be freestanding or attached by using an attaching mechanism. Further, the attaching mechanism may include glue, magnets, etc. Further, the filtering component may include a fabric. Further, the fabric may be perforated. Further, the filtering component may be configured for facilitating performing sound-altering functions such as sound amplification, sound blocking, sound filtering, sound reducing, and sound collecting. Further, the fabric may include a layered fabric such as a pop screen or any woven fabric. Further, the fabric may include a plurality of layers configured for reducing and filtering the wind noise. Further, the fabric may block dirt, dust, and debris from entering at least one microphone and at least one speaker for preventing damage and buildup within. This may reduce or eliminate the hassle of having to clean out at least one microphone hole associated with the at least one microphone which may lead to other mechanical problems if done improperly. Further, in an instance, the filtering component may include a pop shield, a screen, etc. Further, in some embodiments, the layered fabric may be attached to the interior of the smartphone or smartwatch. Further, in some embodiments, the fabric may be placed on either the inside of the device or inside the body or an attachment to cover an external surface of at least one microphone. Further, in some embodiments, the plurality of layers may include layers of interchangeable media and spacer.

Further, in some embodiments, the device case may include a first portion and a second portion. Further, the first portion may be removably attachable to the second portion using a coupling mechanism. Further, the coupling mechanism may include a first part disposed at a first periphery of the first portion and a second part disposed at the second periphery of the second portion. Further, the first part and the second part may be detachably attached. Further, the detachably attaching of the first part and the second part may arrange the device case in an assembled state. Further, in an instance, the coupling mechanism may include a magnetic mechanism, Velcro, etc.

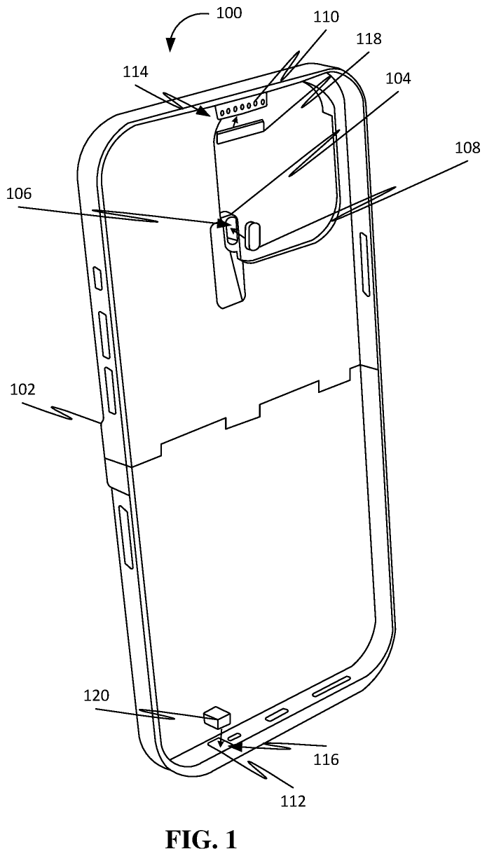

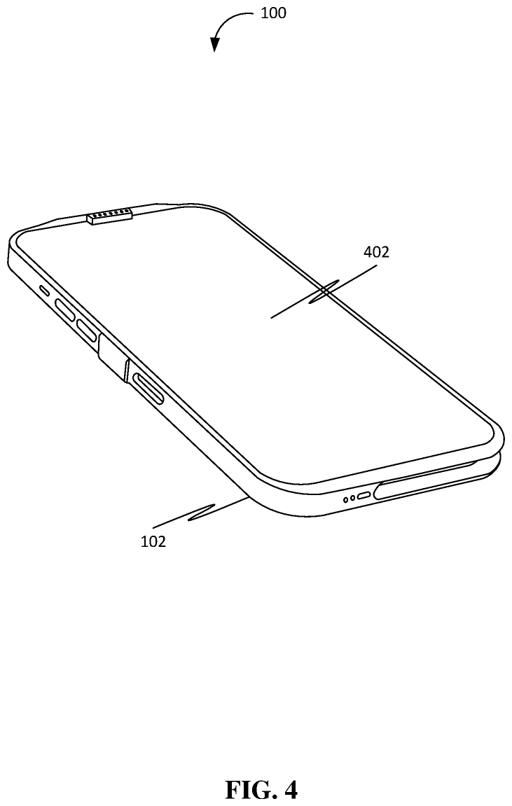

FIG. 1 is an exploded front perspective view of an apparatus 100 for facilitating nullifying environmental sounds for a device (such as a device 402), in accordance with some embodiments. Accordingly, the apparatus 100 may include a cover 102 configured to be attached to an outer surface of the device 402, as shown in FIG. 4. Further, the cover 102 may include a case. Further, the device 402 may include a smartphone, a mobile phone, a smartwatch, a tablet, a desktop, a laptop, etc. Further, the cover 102 may include at least one holder (104, 110, and 112) attached to the cover 102 in at least one location of the cover 102. Further, the at least one holder (104, 110, and 112) defines at least one interior space (106, 114, and 116). Further, the apparatus 100 may include at least one filtering component (108, 118, and 120) configured to be disposed in the at least one interior space (106, 114, and 116). Further, the at least one holder (104, 110, and 112) may be configured for holding the at least one filtering component (108, 118, and 120). Further, the at least one filtering component (108, 118, and 120) may include an insert, a filter, etc. Further, the at least one filtering component (108, 118, and 120) covers at least one opening disposed in the outer surface of the device 402 based on the attaching of the cover 102 to the outer surface of the device 402. Further, the at least one opening leads to at least one cavity in the device 402 for at least one sound capturing device comprised within the device 402. Further, the at least one filtering component (108, 118, and 120) may be comprised of at least one material. Further, the at least one sound capturing device may include a microphone, a sound receiver, etc. Further, the at least one filtering component (108, 118, and 120) may be configured for suppressing a capturing of at least one environmental sound by the at least one sound capturing device based on the at least one material. Further, the at least one filtering component (108, 118, and 120) breaks a wind associated with the at least one environment sound based on passing the wind through the at least one material. Further, the suppressing may be further based on the breaking of the wind. Further, the at least one filtering component (108, 118, and 120) may include a foam.

Further, in some embodiments, the cover 102 may be configured for covering at least a portion of the outer surface of the device 402 based on the attaching.

Further, in some embodiments, the cover 102 may be configured to be removably attached to the outer surface of the device 402.

Further, in some embodiments, the at least one holder (104, 110, and 112) may be detachably attached to the cover 102. Further, the at least one holder (104, 110, and 112) may include at least one attaching element. Further, the at least one attaching element detachably attached the least one holder (104, 110, and 112) to the cover 102. Further, the at least one attaching element may include a magnet. Further, the cover 102 may be comprised of at least one ferromagnetic material.

Further, in some embodiments, the at least one material may include at least one layer of at least one woven fabric. Further, the at least one woven fabric may include cotton, nylon, etc. Further, the at least one woven fabric may include a plain weave, a satin weave, a twill weave, etc. of at least one fabric.

Further, in some embodiments, the at least woven fabric may include at least one of a high density woven fabric and a low density woven fabric.

Further, in some embodiments, the at least one material may be perforated. Further, the at least one material may include a sponge, a foam, etc.

Further, in some embodiments, the at least one filtering component (108, 118, and 120) may be fixedly disposed in the at least one interior space (106, 114, and 116).

Further, in some embodiments, the at least one filtering component (108, 118, and 120) may be removably disposed in the at least one interior space (106, 114, and 116).

Further, in some embodiments, at least a part of the at least one filtering component (108, 118, and 120) inserts into the at least one cavity through the at least one opening based on the attaching of the cover 102 to the outer surface of the device 402. Further, the covering of the at least one opening may be further based on the inserting of the at least one filtering component (108, 118, and 120) into the at least one cavity through the at least one opening.

Further, in some embodiments, the at least one material may include at least one interchangeable media layer. Further, the interchangeable media layer may include at least one of a metal screen layer, a metal mesh layer, a foam material layer, a solid plastic layer, a wood layer, an electrostatic discharge material layer, a rubber layer, a plastic mesh layer, a perforated plastic layer, a fabric layer, a wool layer, a nonporous material layer, and a urethane plastic layer. Further, the interchangeable media layer may perform at least one of sound amplification, sound blocking, sound filtering, sound reducing, and sound collecting.

Further, in some embodiments, the at least one material may include at least one spacer layer associated with the at least one interchangeable media layer. Further, two of the at least one interchangeable media layer may be spaced forming the at least one spacer layer between two of the at least one interchangeable media layer. Further, the at least one spacer layer may be comprised of air.

Further, in some embodiments, the at least one material may include at least one of a closed cell foam and an open cell foam.

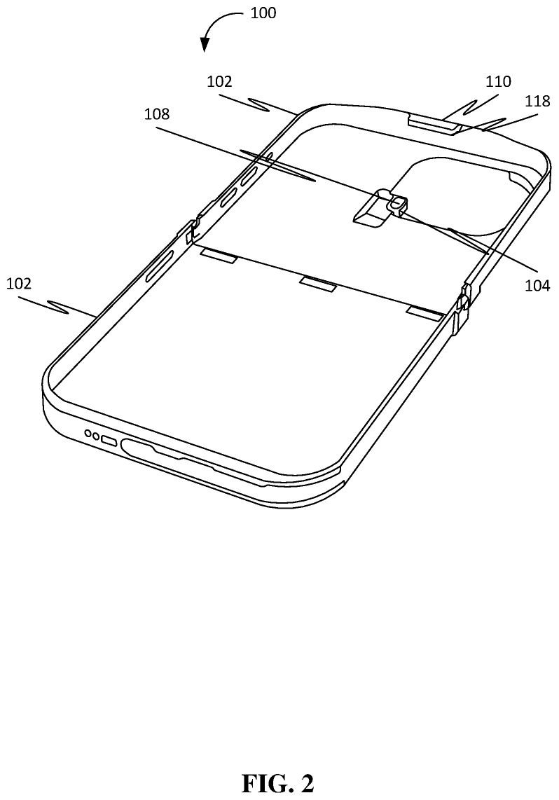

FIG. 2 is a front right side perspective view of the apparatus 100, in accordance with some embodiments.

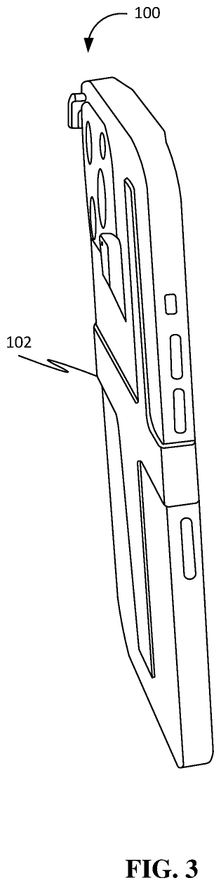

FIG. 3 is a side perspective view of the apparatus 100, in accordance with some embodiments.

FIG. 4 is a front left side perspective view of the apparatus 100 with the device 402, in accordance with some embodiments.

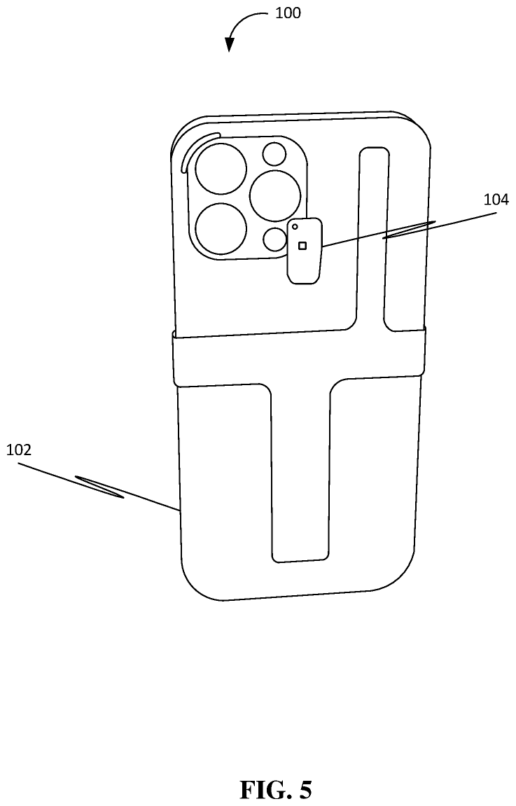

FIG. 5 is a rear view of the apparatus 100, in accordance with some embodiments.

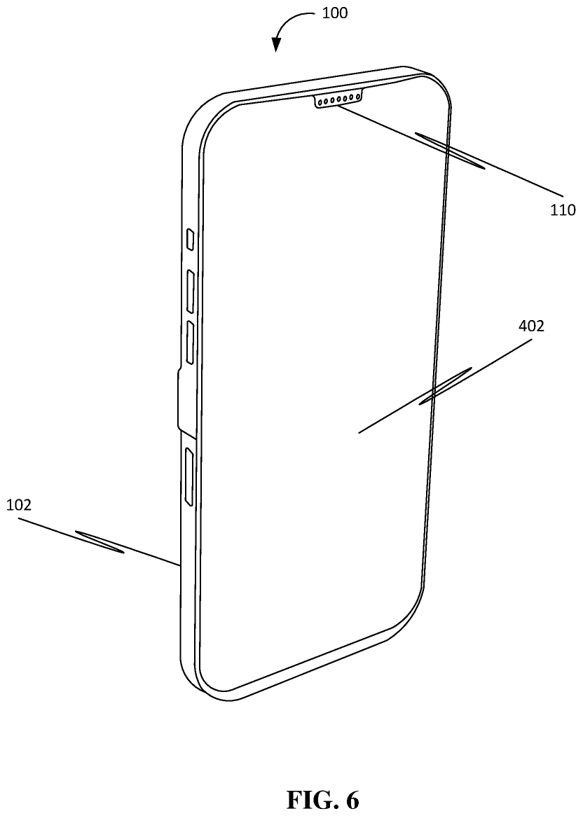

FIG. 6 is a front perspective view of the apparatus 100 with the device 402, in accordance with some embodiments.

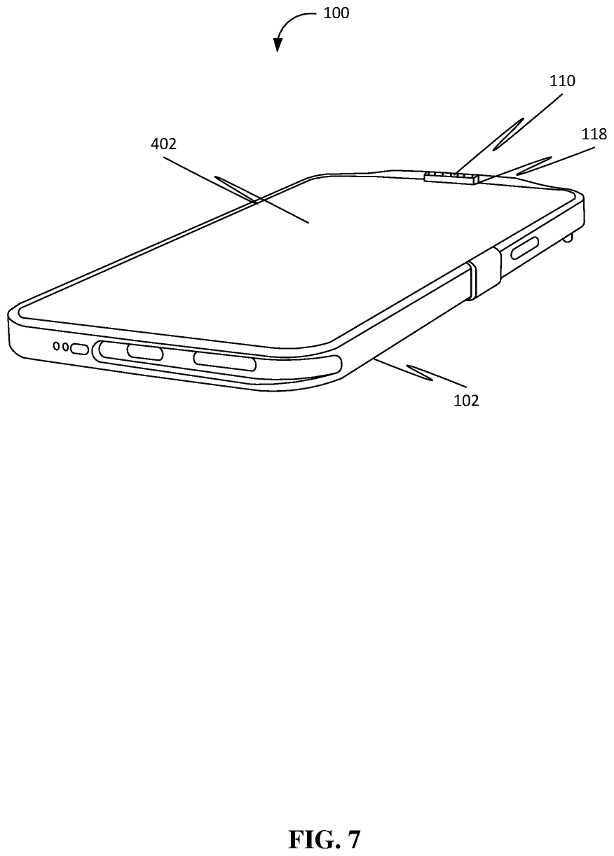

FIG. 7 is a front left side perspective view of the apparatus 100 with the device 402, in accordance with some embodiments.

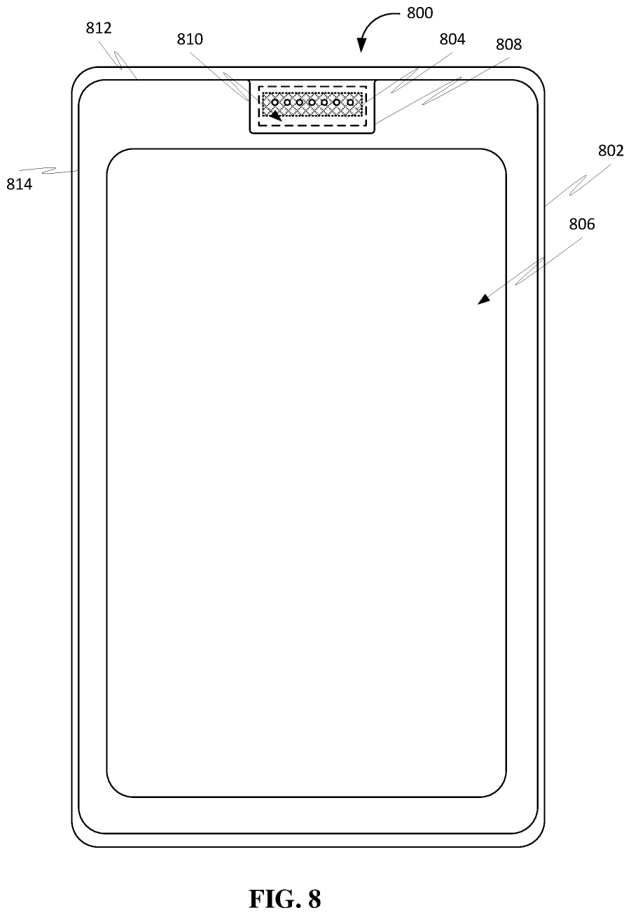

FIG. 8 is a front view of an apparatus 800 for facilitating nullifying environmental sounds for a device, in accordance with some embodiments. Accordingly, the apparatus 800 may include a cover 802 and at least one filtering component (804, 1306, 1214-1216, 1102, and 1008). Further, the cover 802 may be configured to be attached to the device. Further, the cover 802 defines a cover interior space 806 for receiving the device in the cover interior space 806. Further, the attaching to the device may be based on the receiving. Further, the cover 802 may include at least one holder (808, 1002, 1202-1204, and 1302). Further, each of the at least one holder (808, 1002, 1202-1204, and 1302) defines an interior space (810, 1006, 1210-1212, and 1304). Further, the at least one filtering component (804, 1306, 1214-1216, 1102, and 1008) may be disposed in the interior space (810, 1006, 1210-1212, and 1304) of the at least one holder (808, 1002, 1202-1204, and 1302). Further, the at least one holder (808, 1002, 1202-1204, and 1302) may include a first holder 808 disposed on a top portion 812 of a front side 814 of the cover 802. Further, the first holder 808 may extend from the top portion 812 for accommodating a first filtering component 804 of the at least one filtering component (804, 1306, 1214-1216, 1102, and 1008) for covering a first opening of the device for a microphone and/or a speaker comprised in the device.

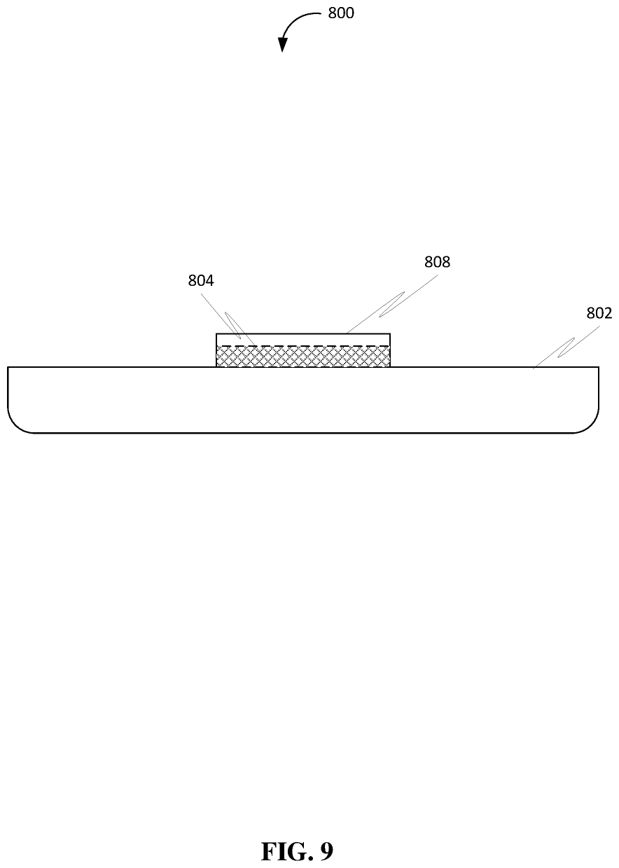

FIG. 9 is a top view of the apparatus 800, in accordance with some embodiments.

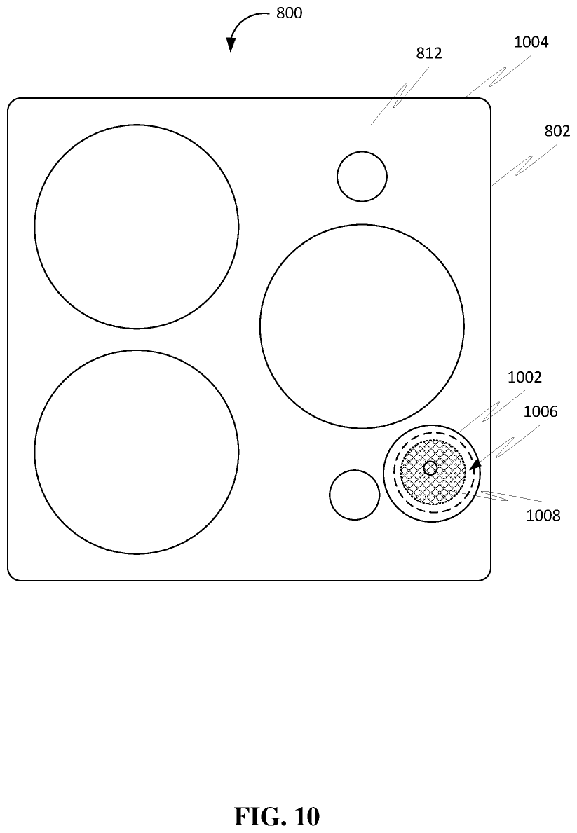

FIG. 10 is an enlarged partial rear view of the apparatus 800, in accordance with some embodiments. Further, the at least one holder (808, 1002, 1202-1204, and 1302) may include a second holder 1002 disposed on the top portion 812 of a rear side 1004 of the cover 802. Further, the second holder 1002 defines a second interior space 1006. Further, the at least one filtering component (804, 1306, 1214-1216, 1102, and 1008) may include a second filtering component 1008. Further, the second filtering component 1008 may be disposed in the second interior space 1006.

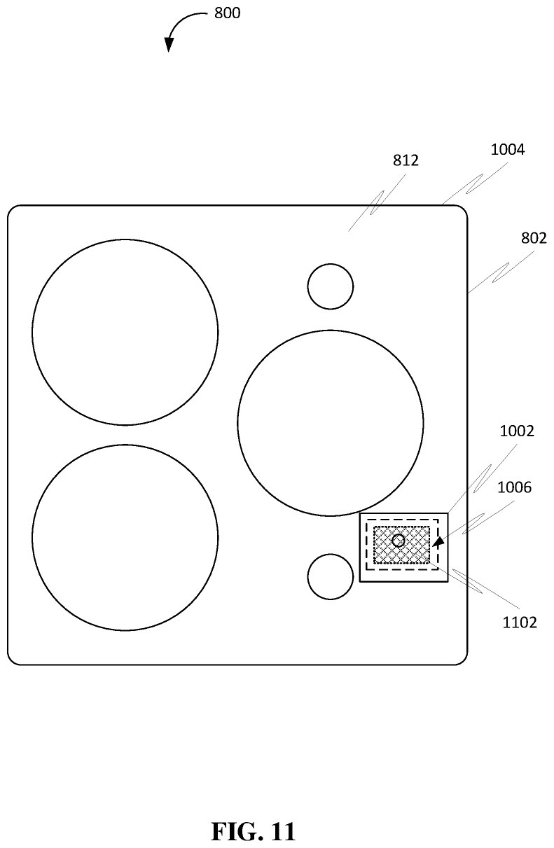

FIG. 11 is an enlarged partial rear view of the apparatus 800, in accordance with some embodiments. Further, the at least one filtering component (804, 1306, 1214-1216, 1102, and 1008) may include a second alternate filtering component 1102. Further, the second alternate filtering component 1102 may be disposed in the second interior space 1006.

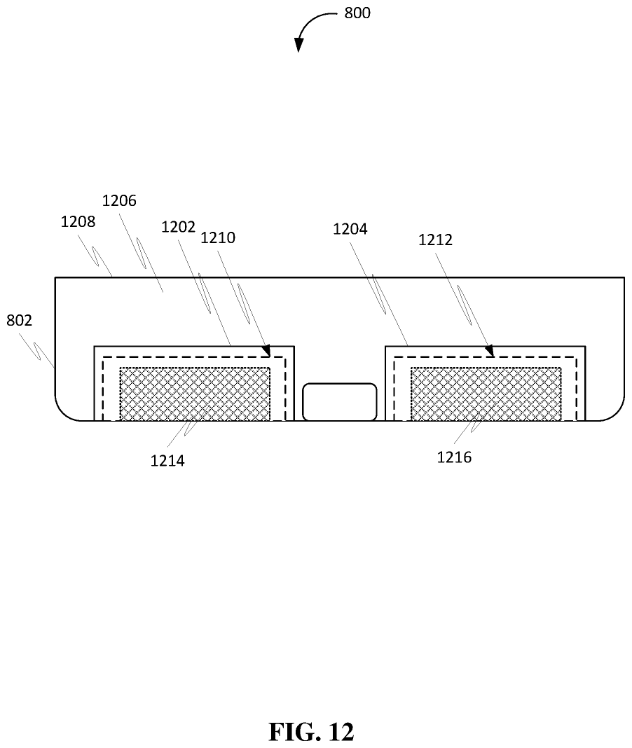

FIG. 12 is a bottom view of the apparatus 800, in accordance with some embodiments. Further, the at least one holder (808, 1002, 1202-1204, and 1302) may include a third holder 1202 and a fourth holder 1204 disposed on a bottom portion 1206 of a bottom side 1208 of the cover 802. Further, the third holder 1202 defines a third interior space 1210 and the fourth holder 1204 defines a fourth interior space 1212. Further, the at least one filtering component (804, 1306, 1214-1216, 1102, and 1008) may include a third filtering component 1214 and a fourth filtering component 1216. Further, the third filtering component 1214 may be disposed in the third interior space 1210 and the fourth filtering component 1216 may be disposed in the fourth interior space 1212.

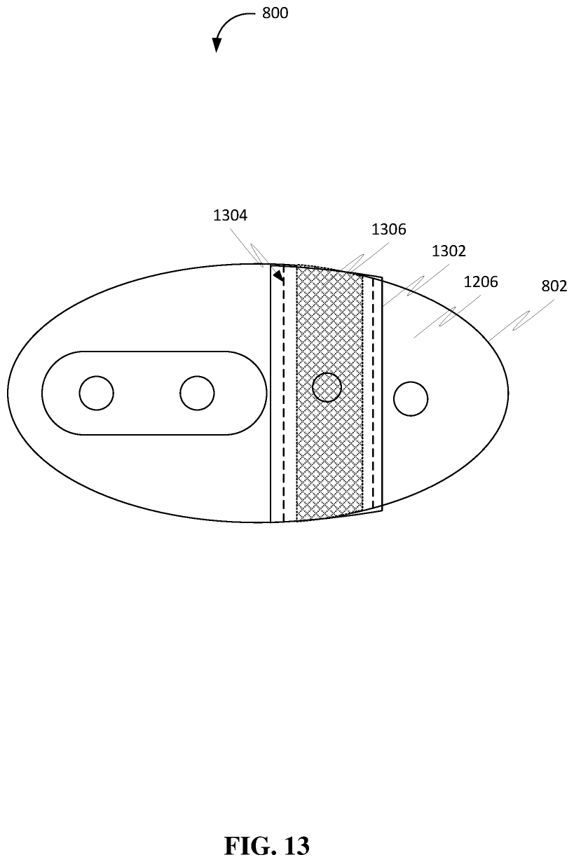

FIG. 13 is an enlarged partial bottom view of the apparatus 800, in accordance with some embodiments. Further, the at least one holder (808, 1002, 1202-1204, and 1302) may include a fifth holder 1302 disposed on the bottom portion 1206 of the bottom side 1208 of the cover 802. Further, the fifth holder 1302 defines a fifth interior space 1304. Further, the at least one filtering component 804, 1306, 1214-1216, 1102, and 1008) may include a fifth filtering component 1306. Further, the fifth filtering component 1306 may be disposed in the fifth interior space 1304.

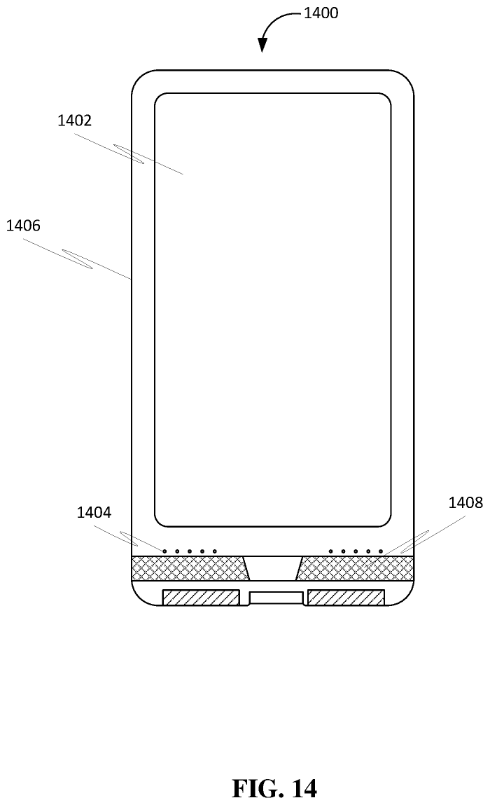

FIG. 14 is a front view of an apparatus 1400 for facilitating nullifying environmental sounds for a phone 1402 with the phone 1402, in accordance with some embodiments. Further, the phone 1402 may include a smartphone, a mobile phone, etc. Further, the phone 1402 may include a speaker and/or a microphone (receiver) 1404. Further, the apparatus 1400 may include a cover (shield) 1406 and a pop screen filter 1408 on the cover 1406.

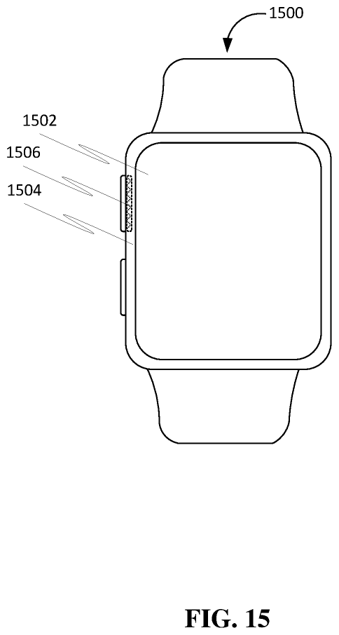

FIG. 15 is a front view of an apparatus 1500 for facilitating nullifying environmental sounds for a smartwatch 1502 with the smartwatch 1502, in accordance with some embodiments. Further, the apparatus 1500 may include a cover (shield) 1504 and a filter 1506 attached to the cover 1504.

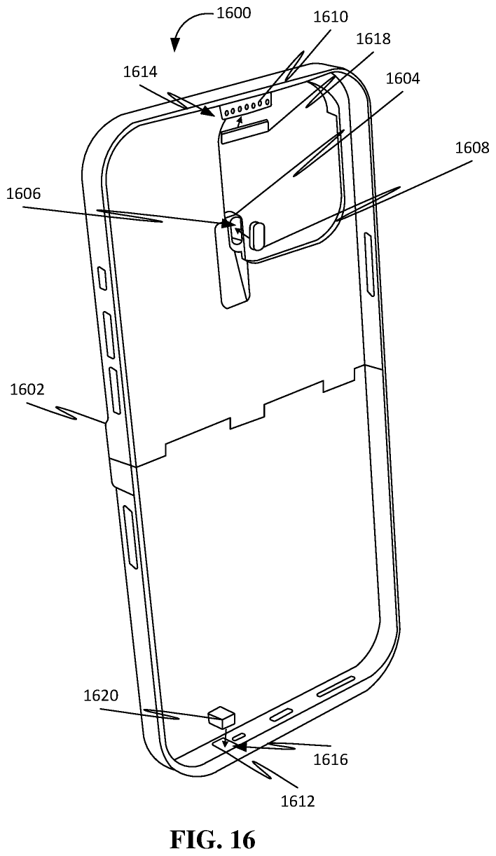

FIG. 16 is an exploded front perspective view of an apparatus 1600 for facilitating nullifying environmental sounds for a device, in accordance with some embodiments. Accordingly, the apparatus 1600 may include a cover 1602 configured to be attached to an outer surface of the device. Further, the cover 1602 may include at least one holder (1604, 1610, and 1612) attached to the cover 1602 in at least one location of the cover 1602. Further, the at least one holder (1604, 1610, and 1612) defines at least one interior space (1606, 1614, and 1616). Further, the apparatus 1600 may include at least one filtering component (1608, 1618, and 1620) configured to be disposed in the at least one interior space (1606, 1614, and 1616). Further, the at least one filtering component (1608, 1618, and 1620) covers at least one opening disposed in the outer surface of the device based on the attaching of the cover 1602 to the outer surface of the device. Further, the at least one opening leads to at least one cavity in the device for at least one sound capturing device comprised within the device. Further, the at least one filtering component (1608, 1618, and 1620) may be comprised of at least one material. Further, the at least one filtering component (1608, 1618, and 1620) may be configured for suppressing a capturing of at least one environmental sound by the at least one sound capturing device based on the at least one material. Further, the at least one material may include at least one interchangeable media layer.

Further, in some embodiments, the cover 1602 may be configured for covering at least a portion of the outer surface of the device based on the attaching.

Further, in some embodiments, the cover 1602 may be configured to be removably attached to the outer surface of the device.

Further, in some embodiments, the at least one holder (1604, 1610, and 1612) may be detachably attached to the cover 1602.

Further, in some embodiments, the at least one filtering component (1608, 1618, and 1620) may be fixedly disposed in the at least one interior space (1606, 1614, and 1616).

Further, in some embodiments, the at least one filtering component (1608, 1618, and 1620) may be removably disposed in the at least one interior space (1606, 1614, and 1616).

Further, in some embodiments, at least a part of the at least one filtering component (1608, 1618, and 1620) inserts into the at least one cavity through the at least one opening based on the attaching of the cover 1602 to the outer surface of the device. Further, the covering of the at least one opening may be further based on the inserting of the at least one filtering component (1608, 1618, and 1620) into the at least one cavity through the at least one opening.

Although the present disclosure has been explained in relation to its preferred embodiment, it is to be understood that many other possible modifications and variations can be made without departing from the spirit and scope of the disclosure.

What is claimed is:

1. An apparatus for facilitating nullifying environmental sounds for a device, the apparatus comprising:
a cover configured to be attached to an outer surface of the device, wherein the cover comprises at least one holder attached to the cover in at least one location of the cover, wherein the at least one holder defines at least one interior space; and
at least one filtering component configured to be disposed in the at least one interior space, wherein the at least one filtering component covers at least one opening disposed in the outer surface of the device based on the attaching of the cover to the outer surface of the device, wherein the at least one opening leads to at least one cavity in the device for at least one sound capturing device comprised within the device, wherein the at least one filtering component is comprised of at least one material, wherein the at least one filtering component is configured for suppressing a capturing of at least one environmental sound by the at least one sound capturing device based on the at least one material.

2. The apparatus of claim 1, wherein the cover is configured for covering at least a portion of the outer surface of the device based on the attaching.

3. The apparatus of claim 1, wherein the cover is configured to be removably attached to the outer surface of the device.

4. The apparatus of claim 1, wherein the at least one holder is detachably attached to the cover.

5. The apparatus of claim 1, wherein the at least one material comprises at least one layer of at least one woven fabric.

6. The apparatus of claim 5, wherein the at least woven fabric comprises at least one of a high density woven fabric and a low density woven fabric.

7. The apparatus of claim 1, wherein the at least one material is perforated.

8. The apparatus of claim 1, wherein the at least one filtering component is fixedly disposed in the at least one interior space.

9. The apparatus of claim 1, wherein the at least one filtering component is removably disposed in the at least one interior space.

10. The apparatus of claim 1, wherein at least a part of the at least one filtering component inserts into the at least one cavity through the at least one opening based on the attaching of the cover to the outer surface of the device, wherein the covering of the at least one opening is further based on the inserting of the at least one filtering component into the at least one cavity through the at least one opening.

11. The apparatus of claim 1, wherein the at least one material comprises at least one interchangeable media layer.

12. The apparatus of claim 11, wherein the at least one material further comprises at least one spacer layer associated with the at least one interchangeable media layer.

13. The apparatus of claim 1, wherein the at least one material comprises at least one of a closed cell foam and an open cell foam.

14. An apparatus for facilitating nullifying environmental sounds for a device, the apparatus comprising:
a cover configured to be attached to an outer surface of the device, wherein the cover comprises at least one holder attached to the cover in at least one location of the cover, wherein the at least one holder defines at least one interior space; and
at least one filtering component configured to be disposed in the at least one interior space, wherein the at least one filtering component covers at least one opening disposed in the outer surface of the device based on the attaching of the cover to the outer surface of the device, wherein the at least one opening leads to at least one cavity in the device for at least one sound capturing device comprised within the device, wherein the at least one filtering component is comprised of at least one material, wherein the at least one filtering component is configured for suppressing a capturing of at least one environmental sound by the at least one sound capturing device based on the at least one material, wherein the at least one material comprises at least one interchangeable media layer.

15. The apparatus of claim 14, wherein the cover is configured for covering at least a portion of the outer surface of the device based on the attaching.

16. The apparatus of claim 14, wherein the cover is configured to be removably attached to the outer surface of the device.

17. The apparatus of claim 14, wherein the at least one holder is detachably attached to the cover.

18. The apparatus of claim 14, wherein the at least one filtering component is fixedly disposed in the at least one interior space.

19. The apparatus of claim 14, wherein the at least one filtering component is removably disposed in the at least one interior space.

20. The apparatus of claim 14, wherein at least a part of the at least one filtering component inserts into the at least one cavity through the at least one opening based on the attaching of the cover to the outer surface of the device, wherein the covering of the at least one opening is further based on the inserting of the at least one filtering component into the at least one cavity through the at least one opening.
